(19) United States
(12) Patent Application Publication
(10) Pub. No.: US 2005/0263482 A1
(43) Pub. Date: Dec. 1, 2005

(54) Method of manufacturing circuit device

(76) Inventors: Sadamichi Takakusaki, Gunma (JP); Motoichi Nezu, Gunma (JP); Takaya Kusabe, Gunma (JP)

Correspondence Address: FISH & RICHARDSON P.C., P.O. BOX 1022, MINNEAPOLIS, MN, 55440-1022, US

(21) Appl. No.: 11/139,142

(22) Filed: May 27, 2005

(30) Foreign Application Priority Data
May 31, 2004 (JP) P. 2004-162655

(51) Int. Cl. H01B 13/00; B44C 1/22

(52) U.S. Cl. 216/13; 216/41

(57) ABSTRACT

In a method of manufacturing a circuit device of the present invention, protruding portions protruding upward are formed in part of a conductive pattern formed on the front surface of a circuit substrate. Next, the front surface of the circuit substrate including the protruding portions is coated with coating resin. Subsequently, the coating resin is etched so that the top surfaces of the protruding portions are exposed. Then, the fixation and electrical connection of circuit elements are performed. Finally, an electric circuit formed on the front surface is sealed, whereby a hybrid integrated circuit device is completed.

### BACKGROUND OF THE INVENTION

Priority is claimed to Japanese Patent Application Number JP2004-162655 filed on May 31, 2004, the disclosure of which is incorporated herein by reference in its entirety.

1. Field of the Invention

The present invention relates to a method of manufacturing a circuit device. In particular, the present invention relates to a method of manufacturing a circuit device having coating resin which coats a conductive pattern.

2. Description of the Related Art

The constitution of a known hybrid integrated circuit device will be described with reference to FIGS. 7A and 7B. This technology is described for instance in Japanese Patent Publication No. Hei 6(1994)-177295 (page 4, FIG. 1). FIG. 7A is a perspective view of the hybrid integrated circuit device 100, and FIG. 7B is a cross-sectional view taken along the X-X′ line of FIG. 7A.

The known hybrid integrated circuit device 100 has the following constitution. The hybrid integrated circuit device 100 includes a rectangular substrate 106, an insulating layer 107 provided on the front surface of the substrate 106, a conductive pattern 108 formed on the insulating layer 107, circuit elements 104 fixed on the conductive pattern 108, thin metal wires 105 electrically connecting the circuit elements 104 to the conductive pattern 108, and leads 101 electrically connected to the conductive pattern 108. Further, the entire hybrid integrated circuit device 100 is sealed with sealing resin 102. Furthermore, the conductive pattern 108 formed on the surface of the insulating layer 107 is coated with coating resin 109, except for portions for electrical connection.

A method of manufacturing the above-described hybrid integrated circuit device will be described. First, the insulating layer 107 is formed on the front surface of the circuit substrate 106 made of metal. Next, the conductive pattern 108 is formed so as to constitute a predetermined circuit. Subsequently, the coating resin 109 is formed so as to coat the conductive pattern 108 except for regions where the circuit elements 104 are to be fixed. Then, through the steps of the fixation of the circuit elements 104, the formation of the sealing resin 102, and the like, the above-described hybrid integrated circuit device 100 is completed.

However, in the above-described method of manufacturing the hybrid integrated circuit device, the coating resin 109 is partially removed in a lithography step, thus exposing the conductive pattern 108. Specifically, the coating resin 109 is spread over the conductive pattern 108 so as to entirely coat the conductive pattern 108, and then the coating resin is selectively removed in a lithography step. However, this method requires design in which margins are incorporated in consideration of the precision of the lithography step. This inhibits the miniaturization of the entire device. Further, the lithography step itself performed for partially removing the coating resin 109 increases the manufacturing cost.

### SUMMARY OF THE INVENTION

The present invention has been accomplished in view of the above-described problems. The present invention provides a circuit device-manufacturing method in which a conductive pattern can be easily exposed from coating resin with high precision.

The present invention provides a method of manufacturing a circuit device. The method includes the steps of: forming on a surface of a circuit substrate a conductive pattern in which protruding portions protruding in a thickness direction are formed; forming coating resin over the surface of the circuit substrate so that the conductive pattern is coated with the coating resin; and etching the coating resin from a surface thereof to expose the protruding portions from the coating resin.

According to the circuit device-manufacturing method of the present invention, the conductive pattern can be partially exposed from the coating resin with high precision without using an exposure mask. Specifically, the protruding portions can be exposed by coating with the coating resin the conductive pattern in which the protruding portions protruding above other regions, and then uniformly removing the coating resin from the surface thereof. Accordingly, the conductive pattern can be partially exposed without performing a lithography step as in the known example. Thus, a pattern can be designed with no consideration given to errors occurring in the lithography step. Consequently, the miniaturization of the entire circuit device can be realized. Furthermore, the elimination of the lithography step makes it possible to provide a circuit device-manufacturing method in which the manufacturing cost is reduced.

### BRIEF DESCRIPTION OF THE DRAWINGS

FIG. 1A is a perspective view of a circuit device of the present invention, and FIGS. 1B and 1C are cross-sectional views thereof.

FIGS. 2A to 2E are cross-sectional views showing a method of manufacturing the circuit device of the present invention.

FIGS. 3A to 3F are cross-sectional views showing the method of manufacturing the circuit device of the present invention.

FIGS. 4A and 4B are cross-sectional views showing the method of manufacturing the circuit device of the present invention, and FIG. 4C is a perspective view showing the same.

FIGS. 5A to 5C are cross-sectional views showing the method of manufacturing the circuit device of the present invention.

FIG. 6 is a cross-sectional view showing the method of manufacturing the circuit device of the present invention.

FIG. 7A is a perspective view of a known circuit device, and FIG. 7B is a cross-sectional view thereof.

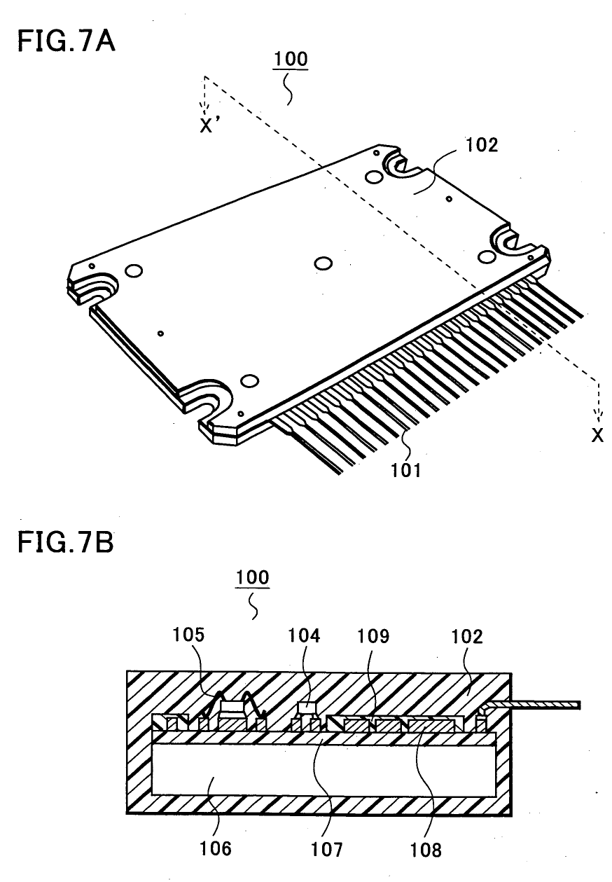

### DESCRIPTION OF THE PREFERRED EMBODIMENTS

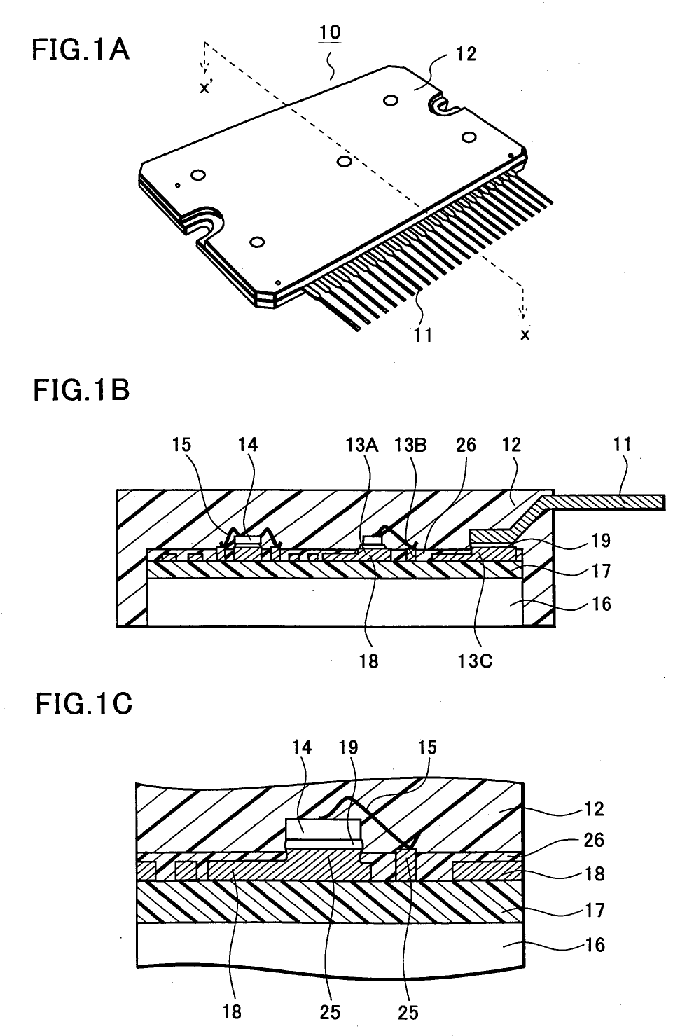

The constitution of a hybrid integrated circuit device 10 as one example of a circuit device of the present invention will be described with reference to FIGS. 1A to 1C. FIG. 1A is a perspective view of the hybrid integrated circuit device 10. FIG. 1B is a cross-sectional view taken along the X-X′ line of FIG. 1A. FIG. 1C is an enlarged cross-sectional view of a region in which protruding portions 25 are formed in a conductive pattern 18.

The hybrid integrated circuit device 10 of this embodiment includes a circuit substrate 16 having an insulating layer 17 formed on the front surface thereof, and the conductive pattern 18 formed on the surface of the insulating layer 17. Further, the conductive pattern 18 is coated with coating resin 26, except for electrical connection regions. Furthermore, circuit elements 14 electrically connected to the conductive pattern 18 are sealed with sealing resin 12. Details of the hybrid integrated circuit device 10 having the above-described constitution will be described below.

The circuit substrate 16 is preferably a substrate made of metal, ceramic, or the like from the viewpoint of heat release. However, the circuit substrate 16 may be a flexible sheet, a printed circuit board made of resin, or the like. At least, a substrate having a front surface insulated is acceptable. Further, as the material of the circuit substrate 16, a metal such as Al, Cu, or Fe can be adopted; or a ceramic such as Al₂O₃ or AlN can be adopted. Other than these, a material which is excellent in mechanical strength and heat release can be adopted as the material of the circuit substrate 16. Further, in the case where Al is adopted as the material of the circuit substrate 16, an oxide film may be formed on the front surface of the circuit substrate 16.

Here, referring to FIG. 1B, the back surface of the circuit substrate 16 is exposed to the outside from the sealing resin 12 in order to suitably release heat generated in the circuit elements 14 mounted on the front surface of the circuit substrate 16 to the outside. Alternatively, the entire circuit substrate 16 including the back surface thereof can also be sealed with the sealing resin 12 in order to improve the moisture resistance of the entire device.

The circuit elements 14 are fixed on the conductive pattern 18. The circuit elements 14 and the conductive pattern 18 collectively constitute a predetermined electric circuit. As the circuit elements 14, an active element such as a transistor or a diode or a passive element such as a capacitor or a resistor is adopted. Further, an element such as a power semiconductor element which generates a large amount of heat may be fixed to the circuit substrate 16 with a metal heat sink interposed therebetween. Here, an active element or the like placed face-up on the circuit substrate 16 is electrically connected to the conductive pattern 18 through thin metal wires 15.

Specific examples of the above-described circuit elements 14 are an LSI chip, a capacitor, a resistor, and the like.

Moreover, in the case where the back surface of a semiconductor element 14A is connected to ground potential, the back surface of the semiconductor element 14A is fixed on the conductive pattern 18 with soldering material, conductive paste, or the like. Further, in the case where the back surface of the semiconductor element 14A is floating, the back surface of the semiconductor element 14A is fixed on the conductive pattern 18 using an insulating adhesive agent. Note that, in the case where the semiconductor element 14A is placed face-down on the circuit substrate 16, the semiconductor element 14A is mounted on the conductive pattern 18 with bump electrodes made of solder or the like interposed therebetween.

Furthermore, as the above-described circuit elements 14, a power transistor, e.g., a power MOS transistor, a GTBT, an IGBT, or a thyristor, which controls a large current, can be adopted. Further, a power IC can also be adopted. In recent years, chips have smaller sizes and thicknesses and high functionalities, and therefore generate large amounts of heat compared to traditional ones. For example, this is true for CPUs which control computers.

The conductive pattern 18 is made of metal such as copper, and formed to be insulated from the circuit substrate 16. Further, pads as part of the conductive pattern 18 are formed along a side of the circuit substrate 16 from which the leads 11 are led out. Here, the plurality of leads 11 are led out from one side edge. However, the leads 11 may be led out from a plurality of side edges. Furthermore, a plurality of layers of conductive patterns 18 may be formed. In this case, the protruding portions 25 are formed in the conductive pattern 18 in the uppermost layer.

The protruding portions 25 are portions protruding above other regions of the conductive pattern 18. The top surfaces of the protruding portions 25 are exposed from the coating resin 26. The top surfaces of the protruding portions 25 are electrically connected to the circuit elements 14 and the leads 11. The protruding heights of the protruding portions 25 are, for example, approximately several tens of μm, and can be increased or decreased as needed.

The insulating layer 17 is formed on the entire front surface of the circuit substrate 16, and has the function of insulating the conductive pattern 18 from the circuit substrate 16. Further, the insulating layer 17 is resin to which alumina such as an inorganic filler has been added at a high concentration, and excellent in thermal conductivity. The distance (minimum thickness of the insulating layer 17) between the lower end of the conductive pattern 18 and the front surface of the circuit substrate 16 is preferably approximately 50 μm or more, though the thickness of the insulating layer 17 varies according to the breakdown voltage. Note that, in the case where the circuit substrate 16 is made of an insulating material, the hybrid integrated circuit device 10 can be constructed with the insulating layer 17 omitted.

The leads 11 are fixed to the pads provided in a peripheral portion of the circuit substrate 16 and, for example, have the function of performing input to and output from the outside. Here, a large number of leads 11 are provided along one side. The leads 11 are bonded to the pads with a conductive adhesive agent such as solder (soldering material).

The sealing resin 12 is formed by transfer molding using thermosetting resin or injection molding using thermoplastic resin. Here, the sealing resin 12 is formed so as to seal the circuit substrate 16 and the electric circuit formed on the front surface thereof. The back surface of the circuit substrate 16 is exposed from the sealing resin 12. Further, a sealing method other than sealing by molding can also be applied to the hybrid integrated circuit device of this embodiment. For example, it is possible to apply a sealing method such as sealing by the potting of resin or sealing using a case member.

The coating resin 26 is formed on the front surface of the circuit substrate 16 so as to coat the conductive pattern 18 with the top surfaces of the protruding portions 25 exposed. The provision of the coating resin 26 can prevent shorting between portions of the conductive pattern 18 caused by conductive dust particles attached thereto during the manufacturing process, and further can prevent the conductive pattern 18 from being damaged during the manufacturing process or in use.

Referring to FIG. 1B, die pads 13A, bonding pads 13B, and pads 13C are portions constituted by the protruding portions 25 partially exposed from the coating resin 26. The circuit elements 14 are fixed to the die pads 13A with soldering material 19. The thin metal wires 15 are bonded to the bonding pads 13B, which are pads electrically connected to the circuit elements 14. The pads 13C are pads to which the leads 11 are fixed with soldering material. The plurality of pads 13C are formed in line in a peripheral portion of the circuit substrate 16.

Referring to FIG. 1C, the top surfaces of the protruding portions 25 are exposed from the coating resin 26. However, portions of the side surfaces of the protruding portions 25 which are continuous with the top surfaces can also be exposed from the coating resin. With this constitution, even in the case where fluctuations occur in etching for removing the coating resin 26, the top surfaces of the protruding portions 26 can be reliably exposed from the coating resin 26. Further, in the case where the circuit elements 14 are fixed to the exposed protruding portions 25 with soldering material such as solder, the bond strength of the soldering material can be improved, because the soldering material can be applied to the protruding portions 26 including even the side surface portions. Furthermore, the thicknesses of the portions of the conductive pattern 18 where the protruding portions 25 are formed increase as the protruding amounts of the protruding portions 25 increases. Thus, the effect of heat release can be improved because the protruding portions 25 function as heat sinks.

Additionally, it is also possible to extend the conductive pattern 18 under a circuit element 14. In this case, the circuit element 14 is insulated from the conductive pattern 18 extended under the circuit element 14 by the coating resin 26 coating the conductive pattern 18. Such a constitution makes it possible to form an interconnection constituting the electric circuit under the circuit element 14, and to improve the wiring density of the entire device.

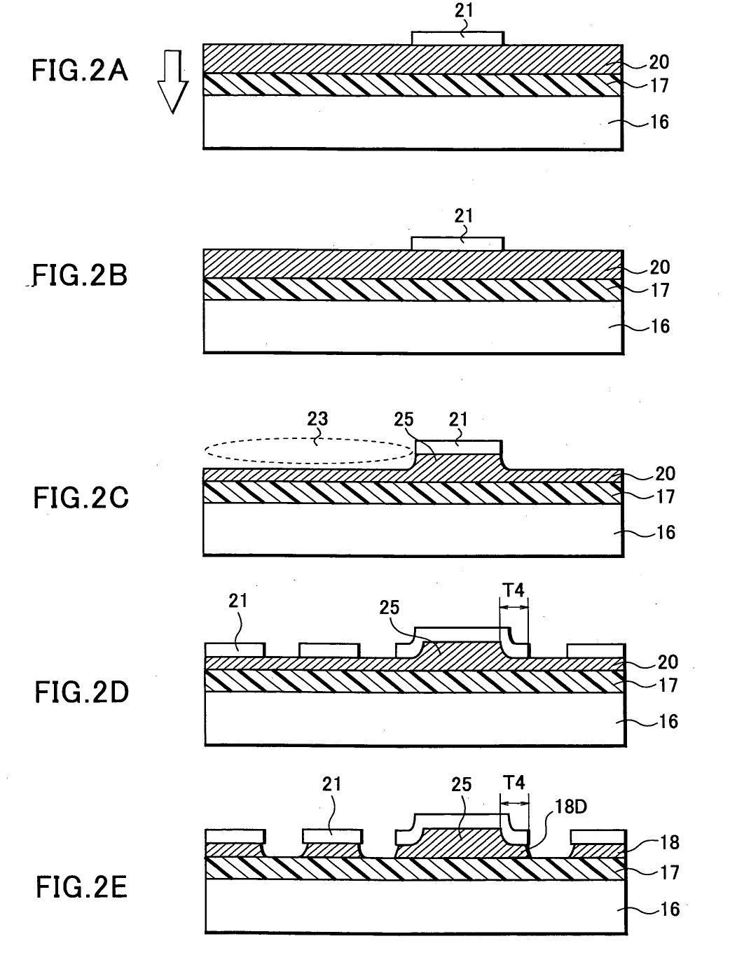

Next, a method of manufacturing the circuit device of this embodiment will be described with reference to FIGS. 2A to FIG. 6.

First Step: in this step, conductive pattern 18 having protruding portions 25 is formed. First, referring to FIGS. 2A and 2B, conductive foil 20 is attached to circuit substrate 16 having the insulating layer formed on the front surface thereof. Then, resist 21 is patterned on the surface of the conductive foil 20. As the material of the conductive foil 20, a material mainly containing copper, or a material mainly containing Fe-Ni or Al can be adopted. The thickness of the conductive foil 20 varies depending on that of the conductive pattern 18 to be formed. The resist 21 coats the surfaces of portions of the conductive foil 20 which correspond to regions where the protruding portions 25 will be formed.

Next, referring to FIG. 2C, wet etching is performed using the resist 21 as a mask, thus etching the main surface in regions where the resist 21 is not formed. By this etching, the surface of the conductive foil 20 is etched in the regions where the conductive foil 20 is not coated with the resist 21, and recessed portions 23 are formed. In this step, the portions coated with the resist 21 become the protruding portions 25 which protrude to be convex. The resist 21 is stripped after this step has been finished.

Next, referring to FIGS. 2D and 2E, the conductive foil 20 attached to the circuit substrate 16 is patterned. Specifically, the resist 21 having a shape according to that of the conductive pattern 18 to be formed is formed, and then wet etching is performed, thus performing patterning. Here, the resist 21 coating the conductive pattern 18 including the protruding portions 25 is formed so as to coat even the peripheral portions of the protruding portions 25. This is the result of considering mask displacement in the patterning of the resist 21. By excessively covering the protruding portions 25 with consideration given to the patterning of the resist 21 as described above, the separation of the conductive foil 20 by etching can be reliably performed. That is, in this embodiment, the conductive pattern 18 is formed so that edge portions 18D are formed in the peripheral portions of the protruding portions 25.

The edge portions 18D are portions formed to extend off the regions where protruding portions 15 are formed, as described above. Accordingly, the edge portions 18D are formed so as to two-dimensionally surround the protruding portions 25. In other words, the resist 21 is formed slightly wider than the protruding portions 25, whereby the edge portions 18D are formed. Stable etching can be performed by widely forming the resist 21 to coat the conductive pattern 18 having the protruding portions 25 formed therein in such a manner that the resist 21 two-dimensionally extends off the protruding portions 25 as described above. That is, since wet etching is isotropic, side etching progresses in the conductive pattern 18, whereby the side surfaces of the conductive pattern 18 formed have tapered shapes. Accordingly, the erosion of conductive pattern 28 by side etching can be prevented by widely performing etching as described above.

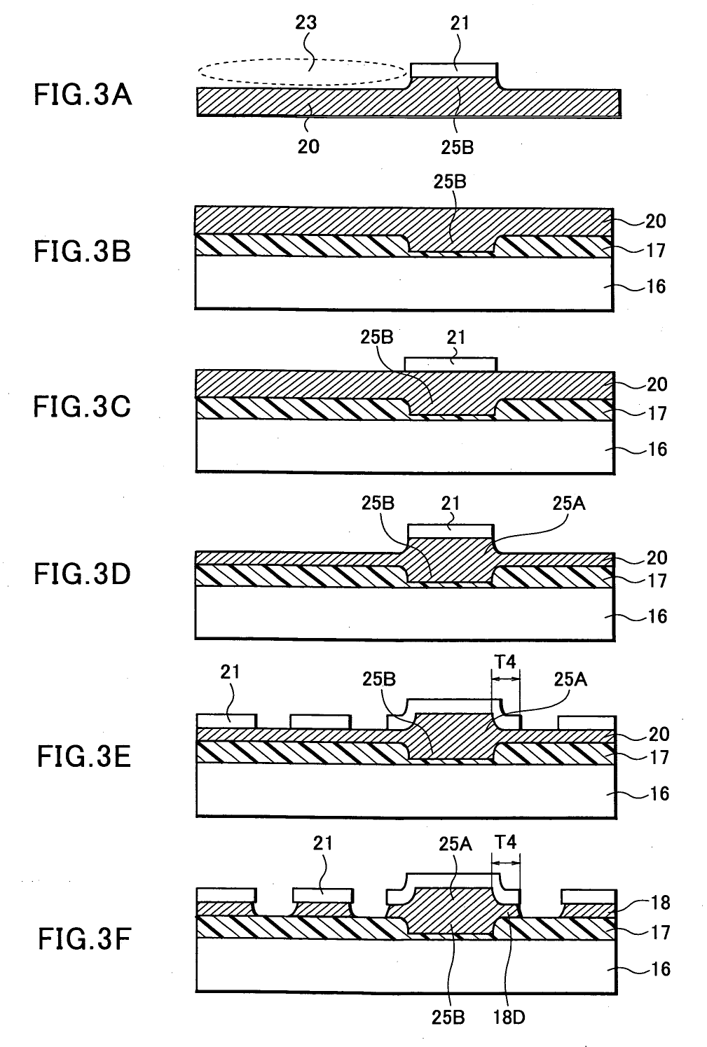

Next, another method of forming the conductive pattern 18 will be described with reference to FIGS. 3A to 3F. The patterning method shown in these drawings is basically the same as the above-described method described with reference to FIGS. 2A to 2E. A difference therebetween is that the protruding portions 25 are provided on both of the front and back surfaces of the conductive pattern 18. The following description will be given with emphasis on this difference. Incidentally, in the following description, the protruding portions protruding upward and exposed from the coating resin are referred to as protruding portions 25A. Further, the protruding portions protruding downward and buried in insulating layer 17 are referred to as protruding portions 25B.

First, referring to FIG. 3A, the protruding portions 25B formed on the back surface are formed. Specifically, the resist 21 is formed in regions corresponding to the protruding portions 25B to be formed, and etching is performed, thus forming the protruding portions 25B.

Referring to FIG. 3B, the conductive foil 20 is tightly attached to the surface of the insulating layer so that the protruding portions 25B are buried in the insulating layer 17. The side surfaces of the protruding portions 25B formed by etching have curved shapes. Accordingly, voids can be prevented from appearing in the portions where the protruding portions 25B are formed.

Next, referring to FIGS. 3C and 3D, resist 21 is formed in order to form the protruding portions 25A protruding upward in the drawing, and etching is performed. Thus, the protruding portions 25A are formed. Here, the protruding portions 25A and the protruding portions 25B are formed at the same positions. However, they may be formed at different positions.

Next, referring to FIGS. 3E and 3F, etching is performed using resist 21 newly formed and patterned, thus forming the conductive pattern 18.

Second Step: in this step, the conductive pattern 18 is coated with the coating resin, except for the protruding portions 25. Specifically, in this step, coating resin 26 is formed so as to entirely cover the conductive pattern 18 including the protruding portions 25, and then the entire surface of the coating resin 26 is etched from the surface thereof. In this step, the protruding portions 25 provided in the conductive pattern 18 are exposed from the coating resin.

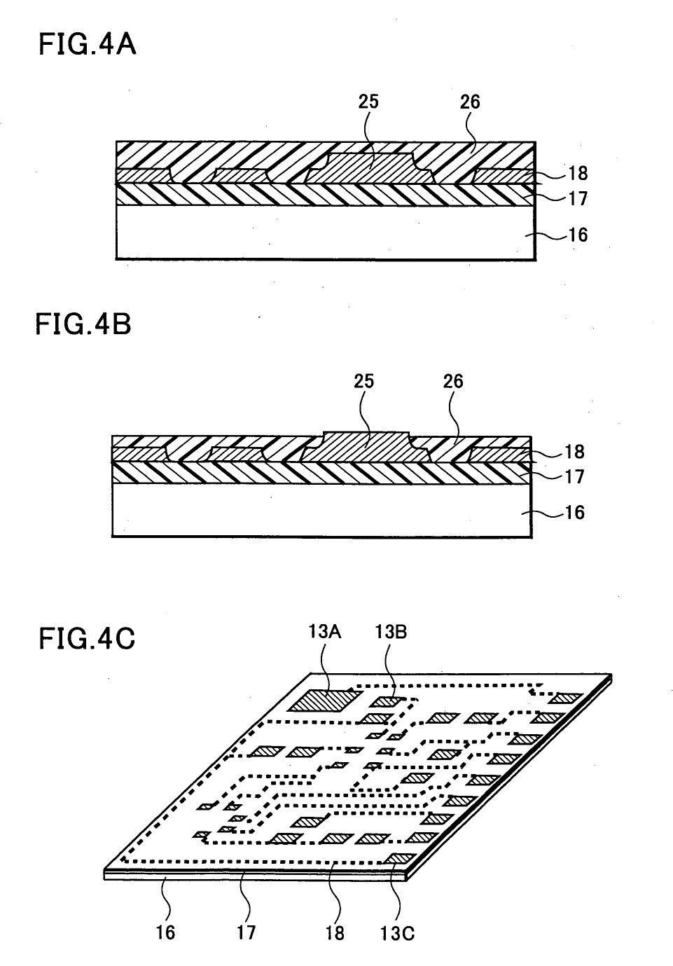

First, referring to FIG. 4A, the coating resin 26 is formed over the front surface of the circuit substrate 16 so as to entirely cover the conductive pattern 18 including the surfaces of the protruding portions 25. As the material of the coating resin 26, either thermosetting or thermoplastic resin can be adopted. Further, methods of forming the coating resin 26 include a method in which a resin sheet is attached to the front surface of the circuit substrate 16. Alternatively, the coating resin 26 can also be formed by applying liquid or semisolid resin to the front surface of the circuit substrate 16. Further, considering a later etching step, the material of the coating resin 26 is preferably resin to which no filler is added. Further, in the case where filler is mixed into the coating resin 26, the amount of the mixed filler is preferably smaller than that of the insulating layer 17. This is because an etching step can be inhibited if a large amount of filler is mixed. Furthermore, in order to uniformly perform later etching, the surface of the coating resin 26 is preferably planarized.

Next, referring to FIG. 4B, the coating resin 26 is etched from the surface thereof, thus exposing the top surfaces of the protruding portions 25 from the coating resin 26. In this step, the entire surface of the coating resin 26 is uniformly etched without using an etching mask. Accordingly, with the progress of etching, the top surfaces of the protruding portions 25 are exposed from the coating resin 26. In this step, etching may be performed until the side surfaces of the protruding portions 25 are exposed, in consideration of fluctuations in etching. Specifically, if the coating resin 26 is etched to the extent that the top surfaces of the protruding portions 25 are exposed, there is a risk that the top surfaces of the protruding portions 25 may not be exposed due to fluctuations in etching. Accordingly, in this embodiment, the coating resin 26 is etched so that even the side surface portions of the protruding portions 25 are exposed, whereby the top surfaces of the protruding portions 25 are reliably exposed.

The state after the protruding portions 25 have been exposed in this step will be described with reference to the perspective view of FIG. 4C. In this drawing, the portions of the conductive pattern 18 which are coated with the coating resin 26 are indicated by dotted lines.

Referring to this drawing, the protruding portions 25 exposed at the surface form a plurality of electrical connection regions, which are referred to as pads in this embodiment. The plurality of pads 13C are formed along one side of the circuit substrate 16. These pads 13C are portions to which the leads to serve as external terminals are fixed. The die pads 13A are pads to which circuit elements 14 such as semiconductor elements are fixed, and have two-dimensional sizes approximately equal to those of the circuit elements 14 to be mounted thereon. Further, the bonding pads 13B are pads which are exposed in order to be electrically connected to the circuit elements 14 using thin metal wires or the like.

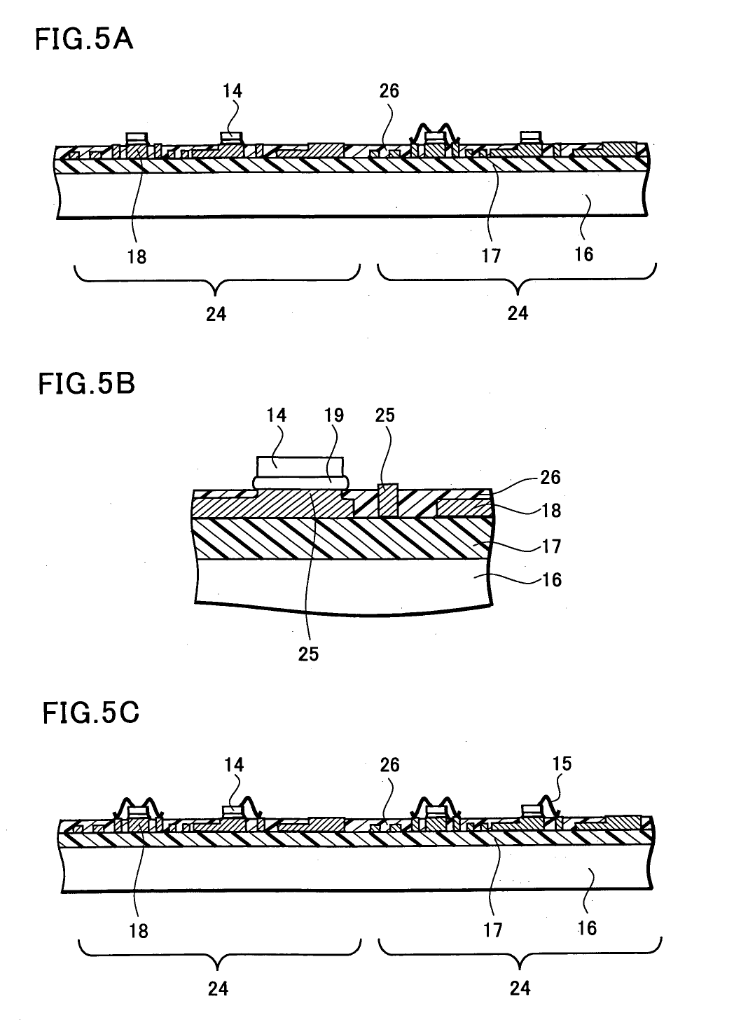

Third Step: in this step, the fixation of the circuit elements and the like are performed. First, referring to FIG. 5A, the circuit elements 14 are fixed to the conductive pattern 18 with solder, conductive paste, or the like. Here, a plurality of units 24, each constituting one hybrid integrated circuit device, are formed on one circuit substrate 16, and die bonding and wire bonding can be performed simultaneously. Here, active elements are placed face-up on the circuit substrate 16. However, they may be placed face-down thereon as needed.

Details of the fixation of the circuit elements 14 with soldering material 19 will be described with reference to FIG. 5B. As described previously, in this embodiment, the top surfaces and even the side surfaces of the protruding portions 25 can be exposed from the coating resin 26. In such a case, the soldering material 19 is applied to cover the top surfaces and side surfaces of the protruding portions 25. By forming the soldering material 19 in this way, the side surfaces of the soldering material 19 can be formed in smooth curved surfaces without constrictions. The soldering material 19 having such a shape can improve reliability against external forces such as thermal stress.

Referring to FIG. 5C, the circuit elements 14 are electrically connected to the conductive pattern 18 with the thin metal wires 15. In this embodiment, the surface of the conductive pattern 18 is coated with the coating resin 26, except for electrical connection portions. Accordingly, even in the case where conductive dust particles are generated in this step, it is possible to prevent shorting between portions of the conductive pattern 18 caused by the attachment of the dust particles thereto.

After the above-described step has been finished, individual units 24 are separated. The separation of the units 24 can be performed by stamping using a pressing machine, dicing, or the like. Thereafter, the leads 11 are fixed to the circuit substrate 16 of each unit.

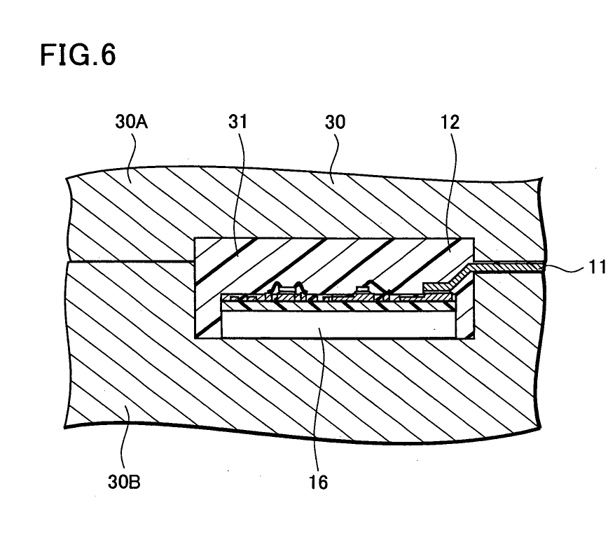

Referring to FIG. 6, each circuit device 16 is sealed with resin. Here, sealing is performed by transfer molding using thermosetting resin. That is, the circuit substrate 16 is contained in a mold 30 including upper and lower mold parts 30A and 30B, and then the two mold parts are engaged, thereby performing the fixation of the leads 11. Subsequently, resin is filled into a cavity 31, thus performing a resin sealing step. By the above-described steps, the hybrid integrated circuit device shown in FIGS. 1A to 1C is manufactured.

1. A method of manufacturing a circuit device, comprising:
forming on a surface of a circuit substrate a conductive pattern in which protruding portions protruding in a thickness direction are formed;
forming coating resin over the surface of the circuit substrate so that the conductive pattern is coated with the coating resin; and
etching the coating resin from a surface thereof to expose the protruding portions from the coating resin.

2. The method according to claim 1, wherein circuit elements are electrically connected to the protruding portions.

3. The method according to claim 1, wherein the protruding portions are exposed by uniformly removing the coating resin from the surface thereof.

4. The method according to claim 1, wherein the etching step is performed until side surfaces of the protruding portions are partially exposed.

5. The method according to claim 1,
wherein the circuit substrate is a substrate made of metal, and
the conductive pattern is formed on a surface of an insulating layer, the insulating layer being formed to cover the surface of the circuit substrate.
